(19) United States
(12) Patent Application Publication
(10) Pub. No.: US 2026/0027691 A1
(43) Pub. Date: Jan. 29, 2026

(54) Remote-controllable power tool for use by a construction robot, and system

(71) Applicant: Hilti Aktiengesellschaft, Schaan (LI)

(72) Inventors: David WÖHRLE, Landsberg (DE); Michael NITZSCHNER, Augsburg (DE); Tobias SCHMID, Emmenhausen (DE); Peter BRUGGER, Feldkirch (AT); Rory BRITZ, Starnberg (DE); Markus HARTMANN, Mauerstetten (DE); Florian HURKA, Margertshausen (DE); Georg FÜRFANGER, München (DE); Mathias FRENZEL, Unterdießen (DE); Klaus HAUSER, Schwabmünchen (DE)

(21) Appl. No.: 18/993,984

(22) PCT Filed: Jul. 21, 2023
(86) PCT No.: PCT/EP2023/070293

§ 371 Date: Jan. 13, 2025

(30) Foreign Application Priority Data
Aug. 3, 2022 (EP) 22188419.0
Oct. 26, 2022 (EP) 22203866.3

(51) Int. Cl. B25F 5/00; B25H 1/00; B25J 11/00

(52) U.S. Cl. CPC B25F 5/006; B25H 1/0042; B25J 11/005

(57) ABSTRACT

An electric power tool (10), in particular a handheld power tool, including a motor (40) and a tool fitting (14) for holding a tool, for example a drilling tool, a cutting tool, and/or a grinding tool, wherein the motor (40) is configured to drive the tool fitting (14). The power tool (10) is remote-controllable. It can have a protection device (42) which is activatable and/or deactivatable by remote control. A system (200) consisting of such a power tool (10) and a construction robot (210) is also provided. The power tool (10) can be used particularly universally and simply, in particular both manually and in an automated fashion by the construction robot (210).

### BACKGROUND

In order to be able to employ a construction robot as flexibly and cost-effectively as possible, it is desirable if the construction robot can be used together with different types of electric power tools.

Low operating costs can be expected in particular if power tools which can be used otherwise could also be used with little effort together with a construction robot.

### SUMMARY OF THE INVENTION

It is an object of the present invention is therefore to provide a power tool which enables both manual use and use automated by means of a construction robot with as little effort as possible to switch between them, and to supply a construction robot with such a power tool.

The present invention provides an electric power tool, in particular a handheld power tool, comprising a motor and a tool fitting for holding a tool, for example a drilling tool, a cutting tool, and/or a grinding tool, wherein the motor is configured to drive the tool fitting, wherein the power tool can be remote-controlled electrically and/or by radio.

This is based on the thought that, although it would in principle be conceivable to use a power tool with a construction robot, in which one or more actuating elements of the power tool are influenced mechanically, for example by means of a hydraulic and/or pneumatic system, such that the power tool can, for example, be switched on and off by the construction robot, such a hydraulic system or such a pneumatic system would each require extensive modifications at the construction robot. The modifications would additionally need to be made specifically for each power tool.

In contrast, the power tool presented here allows it to be remote-controlled by the construction robot. The remote control can take place either by radio and/or via an electrical connection. Extensive additional components for a mechanical control unit of the power tool, in particular for a mechanical control unit adapted specifically to the power tool, are unnecessary.

The power tool can thus be used by the construction robot with little preparation effort and hence particularly cost-effectively.

The power tool nevertheless remains readily usable manually. In particular, neither electrical nor radio-based remote control prevent manual handling of the power tool.

The possibility of such problem-free manual use can result in the power tool being distributed more widely. In particular, the power tool can be a handheld power tool. Economies of scale can thus be used, as a result of which production costs for the power tool can be further reduced.

It is conceivable that the power tool has a data interface, wherein the power tool can preferably be remote-controlled via the data interface.

For example, the data interface can be configured to transmit control commands, property data, and/or status data.

For example, an operating mode and/or an operating state of the power tool can be controlled.

In particular, the power tool can be switched on and/or off by remote control.

It is also conceivable that at least one work output, direction of rotation, rotational frequency, torque, or impact frequency can be set by remote control.

In the case of power tools which have an impact function, it can be favorable if the impact function can also be set by remote control. Thus, the construction robot can, for example in order to drill a hole in concrete, first begin to drill with the impact function deactivated and later activate the impact function in order to minimize the risk of undesired cracked borehole edges.

The power tool can be configured to supply as property data which can be called up, in particular can be called up via the data interface, for example at least one piece of identification data, one performance capability, for example a maximum available impact energy and/or a maximum available work output.

It is also conceivable that the power tool is configured to supply so that it can be called up, in particular can be called up via the data interface, at least one operating state of the power tool, for example at least one rotational speed, temperature, measurement of the wear of a component, or the like.

For this purpose, it is advantageous if the data interface has a bidirectional design. Then, for example, both control commands can be communicated by the construction robot to the power tool and property and/or status data by the power tool to the construction robot. It is also conceivable here that control commands and/or property and/or status data can alternatively or additionally also be transmitted in the respective opposite direction.

The power tool can have at least one protection device for protecting a user during manual use of the power tool.

The protection device can be, for example, a start lock, in particular a restart lock, which prevents the motor from starting just by the application of a supply voltage, in particular with no additional actuation of an actuating element.

The power tool can have an actuating element by means of which the protection device is implemented. The actuating element can be an electric switch, for example a rotary switch, a slide switch, or a rocker switch, an electric button, for example a push button, or an actuator, for example a knob, for example a potentiometer, or a slider.

The power tool can also have a sensor. The sensor can be configured to detect a protection situation. The protection situation can correspond to the case where the protection device is to be activated.

The sensor can be, for example, a proximity sensor, an acceleration sensor, a rotation sensor, a translation sensor, a current and/or a voltage sensor.

The protection device can be configured to reduce or to stop a vibration, a work output, a rotational frequency, a speed, and/or a torque such that, when an event monitored by the protection device occurs, the user is intuitively informed about the occurrence of the monitored event and/or is protected immediately from its consequences.

The protection device can also be configured to block operation of the motor. It is thus possible to prevent use of the power tool until the monitored event no longer exists. Injury to a user can thus be avoided pre-emptively.

The protection device can be deactivatable, in particular activatable and deactivatable. In particular, it can be deactivatable by remote control, in particular activatable and deactivatable by remote control.

Power tools sometimes feature protection devices which are provided for safe use by a human user. For example, a rotational speed controller can be provided such that a rotational speed can be set only after it has been pressed down. Inadvertent operating errors in the case of manual use can thus be avoided.

A further example of a protection device is also a blockage detection unit, for example a unit which detects that a drill bit of a power drill is jammed in a substrate, and/or an automatic torque control unit, in each case in conjunction with an automatic switch-off or at least with an automatic rotational speed reduction.

A further example of a protection device is a restart lock which prevents the motor from being started up without the corresponding switch or controller having been pressed down or generally manually actuated. Such a restart lock is conceivable in particular in the case of cordless power tools in order to avoid undesired start-up when charging a battery of the power tool.

A protection device can also be a vibration damping unit, in particular a vibration damping unit for reducing vibrations of a handle section of the power tool.

It is also conceivable that the protection device is configured to cause the user to make a specific gesture. For example, the power tool can have two actuating elements arranged at different points such that the motor is started only when both actuating elements are actuated simultaneously. It can thus be ensured, for example, that the user holds the power tool in both hands at defined points and consequently, for example, injury to one of their two hands can be ruled out.

Whilst such protection devices can facilitate and/or protect manual use by a human user, they can sometimes make use by a construction robot considerably more difficult or even impossible.

For example, in the last-mentioned example, a construction robot would have to be configured to imitate the specific gesture in order to be able to use the power tool. Otherwise, the power tool could not be used by the construction robot.

In such cases, the range of power tools which can be used by the construction robot can thus be widened if the protection device of the power tool is deactivatable, in particular by remote control. If it is also activatable, in particular by remote control, it can be deactivated if it impedes the use by a construction robot and, as a precaution, be reactivated in other situations.

The power tool can be configured such that the deactivation and/or activation of the protection device takes place actively, in particular by communicating a corresponding control command.

It is also conceivable that the power tool is configured for passive deactivation and/or activation, for example by the power tool automatically detecting whether it is being used manually or in an automated fashion by a construction robot.

The power tool can have a storage battery interface for connecting a storage battery. It can thus be operated without a cord.

At least part of the data interface can be integrated into the storage battery interface. The remote control can then take place via the data interface.

Also presented is a system comprising a construction robot and an electric power tool, wherein the electric power tool is arranged on an end effector of the construction robot, wherein the construction robot is configured to activate and/or deactivate the protection device of the power tool. The power tool can correspond to the above described power tool, wherein it has in any case the protection device.

In the case of such a system, the construction robot can deactivate the protection device before use of the power tool such that it cannot further impede actual use.

Also presented is an interface adapter for connecting an electric power tool to an end effector of a construction robot, wherein the interface adapter has a connection point for connection to a power tool which is designed so that it complements a standard battery interface of a power tool.

One thought on which the invention is based is that electric power tools, in particular battery-powered power tools, for example storage battery-powered handheld power tools such as handheld power drills, in particular masonry power drills, nail guns, power grinding tools, power saws, power chisels, or the like, usually have an energy supply interface, in particular with a uniform design, standardized at least over many types of power tools, for example from the same manufacturer.

Storage battery-powered power tools thus have a standard storage battery interface, by means of which a storage battery conforming to the relevant standard can be installed on the power tool. Here, the standard storage battery interface can perform at least two functions: firstly, the standard storage battery interface can be designed to securely hold the storage battery on the power tool. For this purpose, the standard storage battery interface can, for example, have a latching mechanism.

Secondly, the standard storage battery interface can be configured to transmit operating energy. Here, the operating energy can be transmissible unidirectionally, in particular from the storage battery to the power tool. It can also be transmissible bidirectionally, for example for the purpose of recharging the storage battery by way of recuperation. The standard storage battery interface can have yet further functions. In particular, it can also be configured for signal transmission between the storage battery and the power tool. Said signal transmission can also be unidirectional or bidirectional.

The interface adapter can thus be installed, at one side, on the end effector of the construction robot. By means of the connection point, the interface adapter can, at the other side, be installed on the standard storage battery interface of the power tool, in particular in place of a conventional storage battery. The power tool can thus be installed on the end effector via the interface adapter. This is possible with all power tools that have the same standard storage battery interface, and thus generally with a large number of different types of power tools, in particular ones which can be powered by a storage battery.

In general, standard storage battery interfaces are designed for the fastening of a storage battery without the use of tools and/or for the dismounting of the storage battery without the use of tools. The power tool can thus also be easily and quickly separated from the end effector again, in particular without the need to use a tool.

Since such standard storage battery interfaces commonly have a latching mechanism for fixing the storage battery, it can nevertheless be ensured that the power tool is securely retained on the end effector.

The construction robot can be configured for performing work on a wall and/or on a ceiling, in particular on a building construction site, on a civil engineering construction site, and/or in an industrial plant.

It is conceivable that the interface adapter has a power tool signal interface and a construction robot signal interface for transmitting at least one signal between the construction robot and the power tool. Thus, in addition to a mechanical connection of the construction robot to the power tool, a signal-transmitting connection between the two devices can also be produced by means of the interface adapter.

A signal can be understood to mean at least one control signal and/or at least one sensor signal, for example.

The transmission can be unidirectional or bidirectional.

The interface adapter can also have an additional storage battery interface and/or an additional signal interface by means of which a storage battery can be attached to the interface adapter.

The power tool signal interface and the construction robot signal interface can also be configured for transmitting operating energy. Electrical operating energy can thus be supplied to the power tool. Here, operating energy can be understood to mean the energy that is substantially required for operating the power tool in the conventional manner. Correspondingly, the signal interfaces can be configured to transmit instantaneous electrical powers of at least 0.1 KW, for example of at least 1 kW.

If the interface adapter has the additional storage battery interface and/or the additional signal interface, operating energy can also be transmitted to a storage battery arranged at this or these interfaces, for example for the purpose of charging the storage battery. It can also be possible for operating energy to be transmitted away from said storage battery, for example in order to be able to briefly provide a particularly increased level of electrical power to the power tool.

At least a part of the power tool signal interface can be formed as part of the connection point. For example, the power tool signal interface can use or at least jointly use one or more electrical contacts of the connection point.

It can thus be possible for a sensor signal to be transmitted via the connection point.

It is also conceivable for a separate control interface to be provided for transmitting control signals, for example for switching the power tool on/off or for controlling at least one working parameter, for example a rotational speed. This may be expedient, for example, in the case of power tools in which at least one function that is required for controlling the power tool cannot be controlled via the standard storage battery interface.

The interface adapter can also comprise a signal converter which is configured to convert a signal that is received at one of the signal interfaces, for example to modify a level, an impedance, or a signal coding of the signal, and to output said signal at the other signal interface.

It is conceivable in particular that the signal converter is configured to translate a sensor signal and/or control signal which has been output by the construction robot in “robot language” into a signal form which can be processed by the power tool. It is alternatively or additionally also conceivable that the signal converter is configured to convert a sensor signal and/or control signal from the power tool into a signal form which can be processed by the construction robot.

The construction robot can thus be rendered capable of controlling different types of power tools using signals which are in each case independent of the power tool, or conversely of receiving signals from different power tools.

Here, signals can be transmitted on a half-duplex or full-duplex basis. Said signals can be differential or ground-referenced.

It is alternatively or additionally also possible that the signal converter converts the operating energy which is to be transmitted.

The signal interfaces can be electrical interfaces. For example, provision can be made for at least one signal to be modulated onto the operating energy supply.

It is alternatively or additionally also conceivable that at least one of the signal interfaces is configured for wireless data transmission, in particular for optical and/or radio-based data transmission. For example, it is expedient if the wireless data transmission utilizes a low-energy radio standard. The connection can exhibit automatic coupling. In particular inductive, microwave-based, and/or optical, for example infrared-based, data transmission are conceivable. Such wireless data transmission is reliable even in very dusty environments, such as are commonly encountered on construction sites. Also, such data transmission does not require any mechanical interaction for coupling purposes, thus simplifying coupling and decoupling.

The interface adapter can also have a control unit which is configured to generate a control signal and to output said control signal to at least one of the two signal interfaces.

For this purpose, the interface adapter can have a microcontroller. The microcontroller can have a memory, a microprocessor, and/or program code which can be executed on the microprocessor and which is stored in the memory.

With such a control unit, the interface adapter can control the attached power tool and/or the construction robot. For example, the control unit, in particular the program code, can be configured to detect a fault, for example incorrect arrangement of the power tool on the interface adapter. It can then be configured to transmit a corresponding signal via the construction robot signal interface to the construction robot. For example, the construction robot can commence a fault handling routine in response to the signal. A further example is that the control unit of the power tool transmits an interrogation signal via the power tool signal interface. The power tool can then send back a response signal. For example, in this way, the control unit can interrogate a parameter of the power tool and/or set a parameter.

The control unit can, for example, be configured to interrogate a type or an identifier of the power tool. It can then be configured to set a parameter of the control unit itself, for example a signal converter parameter relating to the conversion, in accordance with the type or the identifier, and/or to transmit the parameter, in this case the type or the identifier, to the construction robot via the construction robot signal interface. It is analogously also conceivable for the control unit to transmit an interrogation signal to the construction robot and to receive a response signal therefrom. Based on the response signal, the control unit can set a parameter of the control unit itself and/or of the power tool.

In particular, the control unit can be configured to receive at least one sensor signal from the power tool signal interface and/or from the construction robot signal interface. The sensor signal can then be used by the control unit for the purpose of control. For example, if the sensor signal relates to vibrations caused by the power tool, the control unit can, if a particular level of vibrations of the power tool is exceeded, transmit a control signal for working with lower power, and/or for assuming a standby mode, via the power tool signal interface. The construction robot can thus be protected against mechanical overload.

Further sensor signals are alternatively or additionally also conceivable, for example sensor signals which indicate at least one characteristic variable of the power tool and/or of the construction robot, for example with regard to vibration, current, force, temperature, power tool type, situation and/or position, a distance of travel, a feed movement, and/or the like.

If the storage battery interface is available, the sensor signal can also relate to a storage battery which is connected to the storage battery interface.

It is also conceivable that the sensor signal indicates an operating mode, and/or that the control unit sets an operating mode, in particular of the power tool.

For example, the behavior of the power tool can thus be adjusted according to whether a storage battery or the interface adapter is attached. For example, depending on the state detected, a trigger can be set or ignored. A wake-up mode can, for example, be triggered. It is also possible for identification codes to be transmitted and/or received by the control unit.

The durability of the construction robot, and/or the precision with which construction work can be carried out, can be improved if the interface adapter has at least one damping element for damping vibrations which act on the interface adapter. The damping element can be configured for passive and/or active damping.

The interface adapter itself can have at least one sensor. The sensor can, for example, be a force sensor and/or a pressure sensor. The interface adapter can then be configured to measure a contact force, a tensile force, and/or the like.

Also presented is a system comprising a construction robot, an interface adapter of the type described above and/or below, and an electric power tool, wherein the electric power tool has a standard storage battery interface, and wherein the standard storage battery interface of the power tool is arranged at the connection point of the interface adapter.

The power tool can in particular have one or more features of the power tools described above. In particular, it can comprise the protection device.

It is conceivable that the system also comprises additional adapter parts. There can thus be power-tool-specific and/or construction-robot-specific adapter parts. These can be used to adapt power tools and/or construction robots to the interface adapter.

The power tool can be configured to detect, in particular via its standard storage battery interface, whether a storage battery or the interface adapter is installed at the standard storage battery interface. It can also be configured to detect whether any element whatsoever is arranged at the standard storage battery interface, and if so to detect in particular what type of element it is. The power tool can thus be configured, for example, to utilize recuperation if a storage battery is installed, and not to utilize recuperation if the interface adapter is installed.

It is also conceivable for the power tool to be modified. It is thus conceivable for a handle insert of the power tool to be at least partly exchanged for a part of the interface adapter or for the interface adapter as a whole.

The construction robot can be designed for carrying out construction work on a building construction site and/or on a civil engineering construction site and/or in an in particular steel-based industrial plant, for example on an oil platform. It can be configured for performing construction work on a ceiling, a wall, and/or a floor. It can be designed for drilling, cutting, chiseling, grinding, and/or setting a structural element. It can have one or more power tools. The power tool can comprise a cutting tool, a grinding tool, and/or a setting tool. It is also conceivable that the end effector and/or the power tool are designed for marking. For example, the end effector can have a paint spraying device. A measuring tool, for example a distance meter, can alternatively or additionally also be arranged on the end effector.

The interface adapter can be installed on the end effector. The power tool and/or the measuring tool can in turn be installed on the interface adapter. The construction robot, in particular the end effector, can in principle also comprise multiple power tools and/or measuring tools.

The construction robot can have a manipulator. The manipulator can be designed as a robot arm. The manipulator can also have a lifting device. The lifting device can increase the size of the overall volume which can be reached by the manipulator. The manipulator can have at least three degrees of freedom. In particular, it can have at least six degrees of freedom.

The construction robot can also have a mobile platform. The mobile platform can comprise a wheeled undercarriage and/or a track-chain undercarriage. The mobile platform can have at least two degrees of freedom. The construction robot can have altogether at least ten degrees of freedom. It is alternatively also conceivable that the mobile platform is or comprises a flying platform. For example, the construction robot can also be designed as a flying drone.

It is also conceivable that the construction robot is activatable via the interface adapter.

It is also conceivable that the power tool is activatable and/or deactivatable via the connection point.

Further features and advantages of the invention are apparent from the following detailed description of exemplary embodiments of the invention, with reference to the figures of the drawings which show details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

Exemplary embodiments of the invention are illustrated in the schematic drawings and explained in detail in the following description.

### BRIEF DESCRIPTION OF THE DRAWINGS

FIG. 1 shows a power tool;

FIG. 2 shows an interface adapter in a side view;

FIG. 3 shows a modified power tool having a power tool adapter part, in a side view;

FIG. 4 shows a power tool during the modification thereof, in a perspective view;

FIG. 5 shows the modified power tool having an installed interface

adapter, in a side view;

FIG. 6 shows an interior view of a part of the interface adapter having a

control unit, in a perspective view;

FIG. 7 shows a system comprising a construction robot, an interface

adapter, and a power tool; and

FIG. 8 shows a simplified block diagram.

### DETAILED DESCRIPTION

In the following description of the figures, comprehension of the invention is facilitated by use of the same reference signs in each case for identical or functionally corresponding elements.

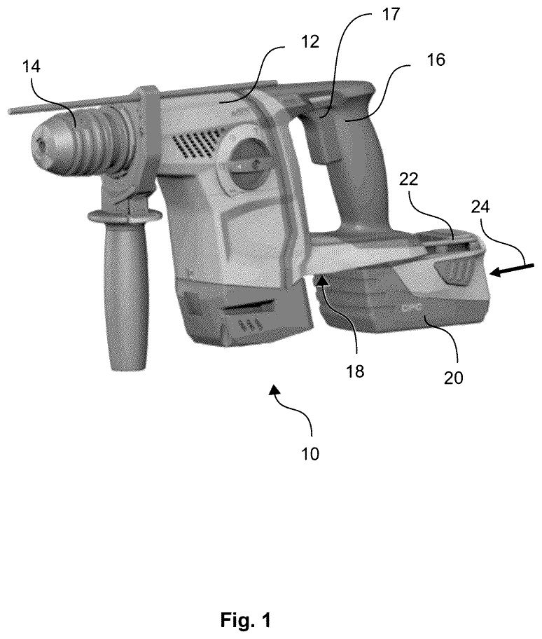

FIG. 1 shows a power tool 10. The power tool 10 is a storage-battery-powered masonry drill.

It has a basic body 12, out of one end of which a tool fitting 14 projects. At the other end, it has a handle 16. Situated on the handle 16 is an actuating element 17 which can be used to manually control the power tool 10. In particular, the actuating element 17 can be used to start and stop a drilling operation or to regulate a rotational speed.

It furthermore has a standard storage battery interface 18. The standard storage battery interface 18 is designed to receive storage batteries. It serves inter alia for fixing the storage battery to the power tool 10, for transmitting operating energy between the storage battery and the power tool 10, and for transmitting signals between same.

By way of example, FIG. 1 shows a storage battery 20, which in the state shown in FIG. 1 has been pushed approximately halfway onto the standard storage battery interface 18.

In order to enable the storage battery 20 to be installed at the standard storage battery interface 18, the storage battery 20 has a connection point 22 which is designed complementarily to the standard storage battery interface 18.

In order to fully install the storage battery 20, it would have to be pushed further onto the standard storage battery interface 18 in the direction of the arrow 24. In order to be fully dismounted, the storage battery would accordingly have to be pushed further off the standard storage battery interface 18 counter to the direction of the arrow 24.

Installation and dismounting are thus possible without the use of tools.

FIG. 2 shows an interface adapter 100 for connecting an electric power tool to an end effector of a construction robot.

The interface adapter has a power tool connection point 110 for connecting to a power tool, for example the power tool 10 according to FIG. 1.

The power tool connection point 110 has a power tool connecting portion 112 which is designed complementarily to the standard storage battery interface 18 (see FIG. 1). The power tool connection point 110 as a whole is thus also designed complementarily to the standard storage battery interface 18.

The power tool connecting portion 112 has electrical contacts 114. If the power tool 10 has been attached to the power tool connection point 110, operating energy, in particular for the purpose of operating the power tool 10, can be transmitted via the contacts 114. For example, provision may be made for an electrical current with a voltage of around 22 V DC voltage to be transmitted as operating energy.

It is also possible for signals to be transmitted bidirectionally from and/or to the power tool 10 via the contacts 114 by virtue of said signals being modulated onto the operating energy that is to be transmitted. The contacts 114, in conjunction with the rest of the power tool connection point 110, in this respect simultaneously form a power tool signal interface 116.

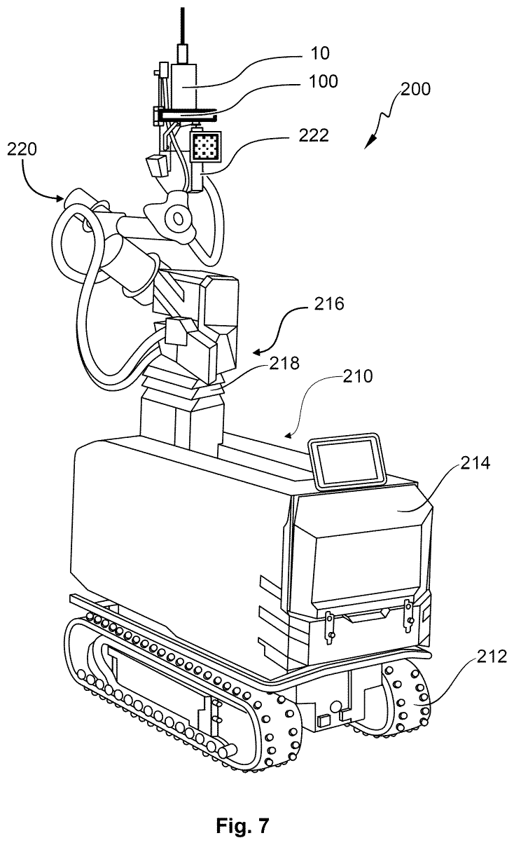

The interface adapter 100 furthermore has a construction robot connection point 118. This serves for connecting to an end effector of a construction robot, for example to the construction robot described in more detail further below in conjunction with FIG. 7.

For the in particular releasable fastening of the interface adapter 100 to the end effector, the construction robot connection point 118 has an in particular pneumatically actuatable bracket 120.

The power tool connection point 110 can be pushed onto a damping element 122 such that the damping element 122 is situated substantially between the power tool connection point 110 and the construction robot connection point 118. Said damping element serves for damping vibrations which can originate, for example, from the power tool 10 during the operation thereof.

Via an electrical contact socket 124, operating energy can be transmitted between an attached construction robot and the interface adapter 100. For example, operating energy can be transmitted in the form of electrical current with a voltage of 48 V.

By modulation, it is also possible for signals to be transmitted, in particular bidirectionally, between the interface adapter 100 and the construction robot via the contact socket 124. The contact socket 124, in conjunction with the rest of the construction robot connection point 118, in this respect simultaneously forms a construction robot signal interface 126.

Signals can thus be communicated between the power tool 10 and the construction robot via the power tool signal interface 116 and via the construction robot signal interface 126.

The interface adapter 100 furthermore has a control unit 128.

The power tool connection point 110 is electrically connected to the rest of the interface adapter 100, in particular to the control unit 128, via a connecting lead 130.

It is also thus possible for operating energy to be transmitted between the construction robot and the power tool 10 via the power tool signal interface 116 and the construction robot signal interface 126.

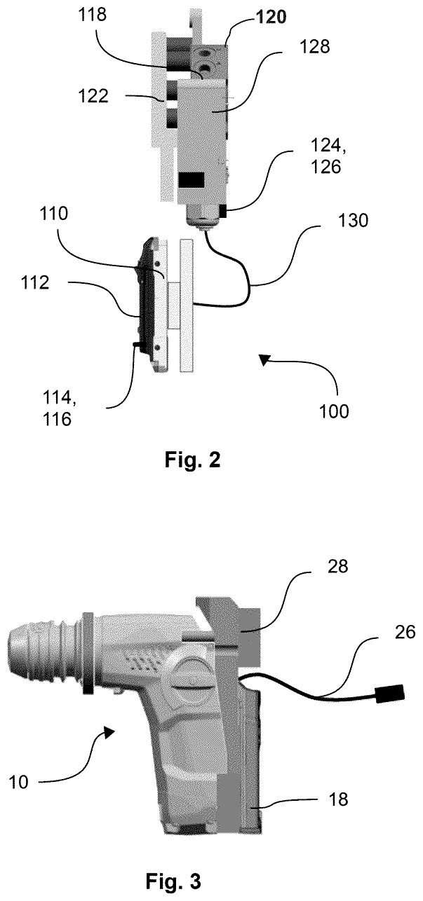

FIG. 3 shows the power tool 10 in a modified form. In comparison with the design in FIG. 1, the handle 16 with the actuating element 17, and the storage battery 20, have been removed.

The manually operable actuating element 17 has been replaced by a control connector 26, such that the control functions of the actuating element 17 are now electronically controllable.

A power tool adapter part 28 has been installed onto the power tool 10 instead of the handle 16.

The standard storage battery interface 18 has been installed, in a pivoted position, on an outer side of the power tool adapter part 28.

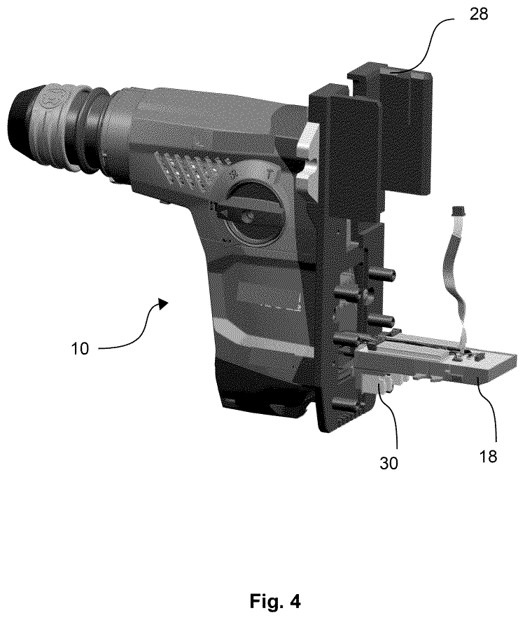

FIG. 4 shows the power tool 10 in a perspective illustration during the modification thereof. It is possible in particular to see the standard storage battery interface 18 which, in a subsequent step corresponding to the illustration in FIG. 4, is to be pivoted by approximately 90° counterclockwise onto the power tool adapter part 28 which has already been installed.

It is also possible to see mating contacts 30 which are formed on the

standard storage battery interface 18 and which are configured to establish electrical contact with the contacts 114 (see FIG. 2).

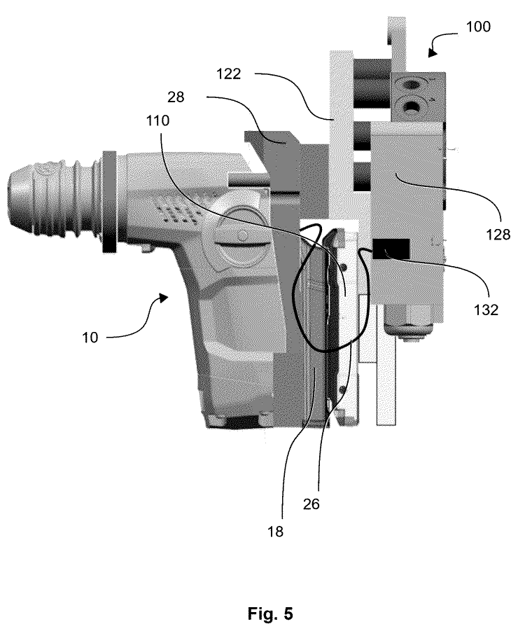

FIG. 5 shows the modified power tool 10 according to FIG. 3, onto which the interface adapter 100 according to FIG. 2 has been installed.

For this purpose, the damping element 122 has been installed, for example screwed, onto the power tool adapter part 28.

The power tool connection point 110 is seated on the standard storage battery interface 18.

The control connector 26 is connected to a control connection socket 132 of the control unit 128.

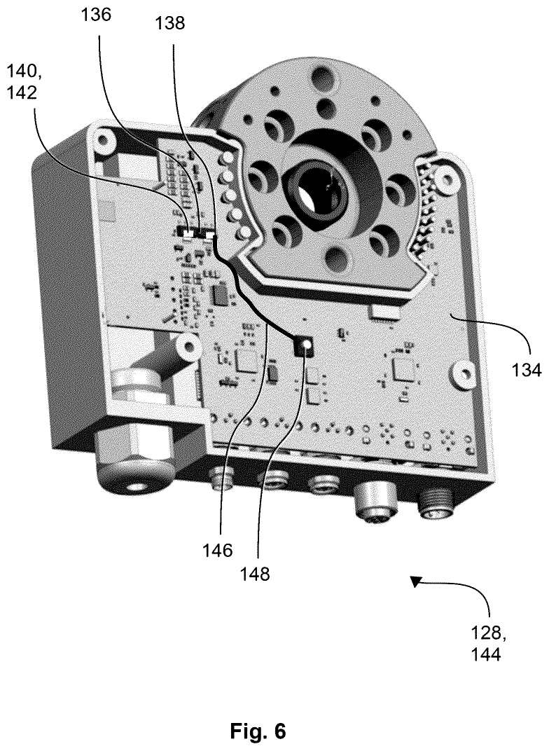

FIG. 6 shows an interior view of the control unit 128 in a perspective illustration.

The control unit 128 comprises an electronic circuit 134 which has, inter alia, a microcontroller 136. The microcontroller 136 has a microprocessor 138 and a memory 140. In the memory 140, there is stored program code 142 which can be executed on the microprocessor 138.

The control unit 128 is configured, inter alia by way of the program code 142, to convert a signal which is received at one of the signal interfaces. In particular, it is configured to convert signals received at a robot signal interface 144, which have been modulated onto a direct current with a voltage of 48 V, into signals which are modulated onto a direct current with a voltage of 22 V, and to output said signals at the power tool signal interface 116. The control unit 128 thus also forms a signal converter 144.

The control unit 128 is furthermore configured, by way of the program code 142, to interrogate sensor signals 146 from a vibration sensor 148. It is furthermore configured to output a braking signal at the power tool signal interface 116 (FIG. 2) if at least one of the sensor signals 146 exceeds a threshold value. On the basis of the braking signal, the power tool 10, which in the present exemplary embodiment is designed as a masonry drill, can, for example, reduce a rotational speed, such that the vibrations caused by said power tool also decrease.

FIG. 7 shows a system 200. The system 200 comprises a construction robot 210, an interface adapter 100, and an electric power tool 10.

The interface adapter 100 corresponds to the interface adapter 100 described with reference to the preceding FIGS. 2, 5, and 6.

The power tool 10 corresponds to the power tool 10 described with reference to the preceding FIGS. 1, 3, 4, and 5.

The construction robot 210 has a mobile platform 214 equipped with a track-chain undercarriage 212. A manipulator 216 is arranged on the mobile platform 214. The manipulator 216 has a lifting device 218 on which a multi-axis arm 220 is installed. The lifting device 218 can move the arm 220 in a vertical direction. The arm 220 has at least six degrees of freedom. Thus, an end effector 222 arranged on a working end of the arm 220 can be oriented both vertically and horizontally. The construction robot 210 can thus perform construction work, in particular drilling work using the power tool 10 designed as a masonry drill, on ceilings, walls, and/or floors.

The interface adapter 100 is arranged on the end effector 222. Its construction robot signal interface 126 (see FIG. 2) is connected to a corresponding signal output of the construction robot 210.

Inter alia, the standard storage battery interface 18 (see FIG. 2) of the power tool 10 is arranged on the power tool connection point 110 (see FIG. 2) of the interface adapter 100.

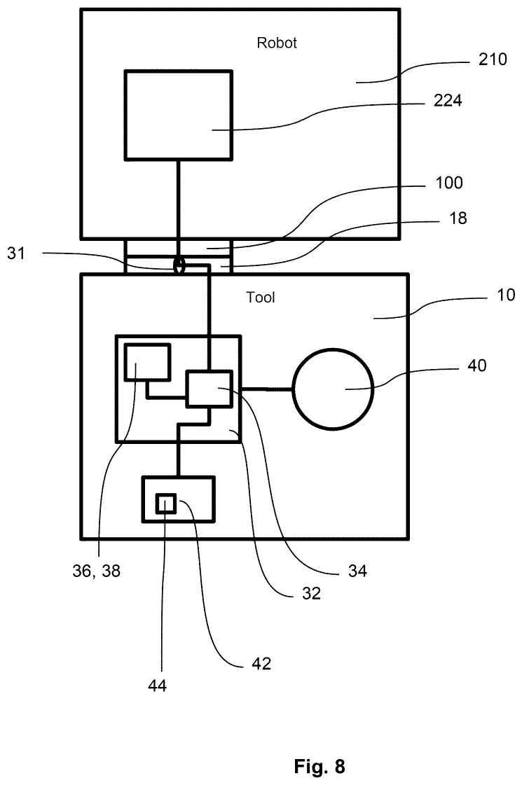

FIG. 8 shows a simplified block diagram of the system 200. The illustration according to FIG. 8 is restricted, in simplified fashion, to the features which are explained in detail below. Unless described otherwise, the elements explained in detail below correspond in each case to the corresponding elements described above.

It is illustrated that the system 200 comprises the construction robot 210 and the electric power tool 10.

The power tool 10 is, as described above, connected to the construction robot 210 via the interface adapter 100 and the storage battery interface 18.

The power tool 10 has a power tool control unit 32. The latter comprises a power tool microcontroller 34 and a power tool memory 36. In the power tool memory 36, there is stored power tool program code 38 which can be executed on the power tool microcontroller 34. The program code 38 and the power tool microcontroller 34 as a whole are configured in such a way to control elements of the power tool 10.

In particular, the power tool control unit 32 is configured to control a motor 40 of the power tool. The motor 40 is configured to drive the tool fitting 14 (see FIG. 1).

Data, in particular signals and operating data of the power tool 10, can be transmitted bidirectionally between the construction robot 210 and the power tool via a data interface 31. The data interface 31 is integrated into the storage battery interface 18.

In particular, as also described above, the power tool 10 can be remote-controlled by the construction robot 210. To do this, control signals can be transmitted from a construction robot control unit 224 of the construction robot 210 to the power tool control unit 32 via the interface adapter 100 and the data interface 31.

The power tool 10 has a protection device 42 for protecting a user during manual use of the power tool 10. The protection device 42 comprises a sensor 44.

The protection device 42, in particular the sensor 44, is configured to detect a blockage of a tool held in the tool fitting and to notify this blockage to the power tool microcontroller 34 by means of a blockage signal.

By means of the power tool program code 38, the power tool microcontroller 34 is in a manual operating mode activated in a standard fashion and thereby configured to decelerate the motor 40 to a standstill when the blockage signal is received.

However, the construction robot control unit 224 can transmit a deactivation signal to the power tool microcontroller 34 such that the latter, in turn by means of the power tool program code 38, switches into an automatic operating mode. In this automatic operating mode, the power tool microcontroller 34 does not react to any blockage signals received from the protection device 42. The protection device 42 is thus deactivatable by remote control.

The construction robot control unit 224 can analogously cause the power tool microcontroller 34 to switch back into manual operating mode by means of an activation signal. The protection device 42 is thus also activatable by remote control.

It is provided here that the construction robot control unit 224, before performing a construction task, in this case before beginning to drill into stone, deactivates and then reactivates the protection device 42.

### LIST OF REFERENCE SIGNS

10 power tool
12 basic body
14 tool fitting
16 handle
17 actuating element
18 storage battery interface
20 storage battery
22 connection point
24 arrow
26 control connector
28 adapter part
30 mating contact
31 data interface
32 power tool control unit
34 power tool microcontroller
36 power tool memory
38 power tool program code
40 motor
42 protection device
44 sensor
100 interface adapter
110 power tool connection point
112 power tool connecting portion
114 contact
116 power tool signal interface
118 construction robot connection point
120 bracket
122 damping element
124 contact socket
126 construction robot signal interface
128 control unit
130 connecting lead
132 control connection socket
134 circuit
136 microcontroller
138 microprocessor
140 memory
142 program code
144 signal converter
146 sensor signal
148 vibration sensor
200 system
210 construction robot
212 track-chain undercarriage
214 mobile platform
216 manipulator
218 lifting device
220 arm
222 end effector
224 construction robot control unit

What is claimed is:

1-11. (canceled)

12. An electric power tool comprising:
a motor; and
a tool fitting for holding a tool, the motor configured to drive the tool fitting, the power tool being remote-controllable electrically or by radio.

13. The power tool as recited in claim 12 further comprising a data interface.

14. The power tool as recited in claim 13 wherein the power tool is remote-controllable via the data interface.

15. The power tool as recited in claim 13 wherein the data interface has a bidirectional design.

16. The power tool as recited in claim 12 further comprising at least one protector for protecting a user during manual use of the power tool.

17. The power tool as recited in claim 16 wherein the protector is configured to reduce or to stop a vibration, a work output, a rotational frequency, a speed, or a torque.

18. The power tool as recited in claim 16 wherein the protector is configured to block operation of the motor.

19. The power tool as recited in claim 16 wherein the protector is deactivatable.

20. The power tool as recited in claim 19 wherein the protector is deactivatable by remote control.

21. The power tool as recited in claim 19 wherein the protector is activatable.

22. The power tool as recited in claim 21 wherein the protector is activatable and deactivatable by remote control.

23. The power tool as recited in claim 12 further comprising a storage battery interface for connecting a storage battery.

24. The power tool as recited in claim 23 further comprising a data interface, at least a part of the data interface being integrated into the storage battery interface.

25. The power tool as recited in claim 12 wherein the power tool is a handheld power tool.

26. The power tool as recited in claim 12 wherein the tool is a drill, a cutter or a grinder.

27. A system comprising:
a construction robot; and
an electric power tool as recited in claim 12, the electrical power tool having at least one protector for protecting a user during manual use of the power tool, the electric power tool being arranged on the construction robot, the construction robot being configured to activate or deactivate the protector.
